(19) United States
(12) Patent Application Publication
(10) Pub. No.: US 2014/0190357 A1
(43) Pub. Date: Jul. 10, 2014

(54) Bottle Temperature Control Apparatus

(71) Applicant: Ka Chun MAK, Hong Kong (HK)

(72) Inventor: Ka Chun MAK, Hong Kong (HK)

(21) Appl. No.: 13/736,962

(22) Filed: Jan. 9, 2013

(51) Int. Cl. A47J 36/24

(52) U.S. Cl. CPC A47J 36/2438
USPC 99/453; 219/441

(57) ABSTRACT

A bottle temperature control apparatus includes a main heat-generating band configured to wrap around a bottle. The band is provided with at least one heater, a temperature sensor, a controller configured to activate the heater when the temperature measured by the sensor drops below a predetermined temperature range and deactivate the heater when the temperature measured by the sensor rises above the predetermined temperature range. The band further includes an electrical connector for connection to a supplemental heat-generating band.

### FIELD OF TECHNOLOGY

The present application relates to a bottle temperature control apparatus.

### BACKGROUND

The stomach and intestine of a baby are more sensitive than those of an adult because they are not fully developed. The temperature of milk for babies should be between 37-42° C. which is close to the temperature of a human body and breast milk. Milk temperature that is too low may lead to sensitive stomach and intestine, lack of appetite, milk vomiting and stomach illness. This may obstruct the absorption of nutrient and affect the growth and development of a baby. Milk temperature that is too high may burn the body of the baby.

It is not easy to control the temperature of milk inside a baby bottle. One conventional device is a baby bottle warmer that has a water container and a heater for heating up water in the container. A user first pours water into the container and then switches the heater on to heat up the water. After the water inside the container is heated up, the user then places the baby bottle into the heated water so as to keep the milk inside the baby bottle at a warm temperature. This kind of baby bottle warmer has many disadvantages. (1) It is rather troublesome because it requires the addition of water and heating up the water before a baby bottle can be placed inside the heated water for warming up the milk inside the baby bottle. (2) It is not possible to warm up the milk inside the baby bottle during feeding. (3) It is not convenient to use and carry the baby bottle warmer around because it requires AC power. (4) A feeder is not aware of the temperature of the milk inside the baby bottle because the baby bottle warmer does not have the function of monitoring the milk temperature and would render the milk temperature to get too cold or too hot.

Another conventional device is a baby bottle warming pouch. It is in the form of a pouch having embedded electrical wires to heat up a baby bottle placed inside the pouch. This kind of baby bottle warming pouch also has many disadvantages. (1) It is not possible to warm up the milk inside the baby bottle during feeding. (2) It is not convenient to use and carry the warming pouch around because it requires AC power. (3) A feeder is not aware of the temperature of the milk inside the baby bottle because the warming pouch does not have the function of monitoring the milk temperature and would render the milk temperature to get too cold or too hot. (4) It cannot automatically stop the heating process when the temperature reaches a suitable temperature. It wastes electricity and renders the milk temperature to get too high. (5) A user cannot adjust the position of the heating wires embedded inside the pouch to a position of the milk inside the baby bottle. This causes a waste of electrical energy. (6) A user cannot see the milk inside the baby bottle because the baby bottle is placed and hidden inside the pouch. (7) A user cannot adjust the size of the pouch so that the heating wires embedded inside the pouch can be in close contact with the baby bottle. This certainly affects the heating efficiency of the pouch.

There is a desire to produce an improved bottle temperature control device that can alleviate at least some of the disadvantages of the above-mentioned conventional baby bottle warming and temperature controlling devices.

The above description of the background is provided to aid in understanding a bottle temperature control apparatus, but is not admitted to describe or constitute pertinent prior art to the bottle temperature control apparatus disclosed in the present application, or consider any cited documents as material to the patentability of the claims of the present application.

### SUMMARY

According to one aspect, there is provided a bottle temperature control apparatus including a heat-generating band configured to wrap around an exterior wall of a bottle (e.g. baby bottle) and provided with a heater, a temperature sensor mounted on the heat-generating band in contact with the exterior wall of the bottle for measuring the temperature of the liquid therein when the heat-generating band is wrapped around the exterior wall of the bottle, and a controller mounted on the heat-generating band and connected to the heater and the temperature sensor. The controller can be configured to activate the heater when the temperature measured by the temperature sensor drops below a predetermined temperature range and deactivate the heater when the temperature measured by the temperature sensor rises above the predetermined temperature range. The bottle temperature control apparatus also includes an electrical connector coupled to the controller and adapted to be connected to a supplemental heater. The electrical connector may be connected to the supplemental heater by an electrical wire. The heat-generating band can be moved up or down or around the exterior wall of the bottle thereby moving the heater and the temperature sensor to a position where the liquid is located whether the bottle is oriented upright, sideway, or in an inverted and tilted feeding position.

In one embodiment, the heat-generating band may have two opposite ends provided with two cooperating fastening members respectively. The heat-generating band can have a length sufficient to wrap around the exterior wall of bottles of various sizes. The heat-generating band may be provided with a transparent window through which the liquid and liquid level inside the bottle can be revealed.

In one embodiment, the controller may include a switch to switch a power supply of the controller on or off. The controller may include a central processing unit configured to receive data transmitted from the sensor, display the data on a display, process the data, activate the heater when the temperature measured by the temperature sensor drops below a predetermined temperature range, and deactivating the heater when the temperature measured by the temperature sensor rises above the predetermined temperature range. The controller may include a circuit board with a central processing unit configured to automatically activate the heater when the temperature measured by the temperature sensor drops below a predetermined temperature range, and automatically deactivate the heater when the temperature measured by the temperature sensor rises above the predetermined temperature range. The controller may include a display for displaying the temperature being measured by the temperature sensor. The display may display a warning message “TOO COLD” when the temperature measured by the temperature sensor drops below the predetermined temperature range, and display a warning message “TOO HOT” when the temperature measured by the temperature sensor rises above the predetermined temperature range. The controller may be accommodated in a controller housing which is hingedly connected to the heat-generating band at an outer side thereof by a hinge. The controller may include a battery for supplying electric energy to the sensor, the heater and the controller.

In one embodiment, the heat-generating band may include a guiding rail extending transversely thereon, whereby the temperature sensor can be slidably coupled to the guiding rail and movable between a first position where the temperature sensor is located at one side of the heat-generating band and a second position where the temperature sensor is located at the other side of the heat-generating band.

In one embodiment, the heater may be sandwiched between an inner conductive layer in contact with the exterior wall of the bottle and an outer insulating layer.

In one embodiment, the apparatus further includes a supplemental heat-generating band configured to wrap around the exterior wall of the bottle and carrying a supplemental heater. The supplemental heat-generating band may be provided with a transparent window through which the liquid and liquid level inside the bottle can be revealed.

In one embodiment, the apparatus may include a plurality of heaters disposed around the exterior wall of the bottle.

In one embodiment, the temperature sensor can be fixedly coupled to a slide button so as to facilitate the sliding of the temperature sensor along the guiding rail.

Although the bottle temperature control apparatus disclosed in the present application is shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the bottle temperature control apparatus disclosed in the present application will now be described by way of example with reference to the accompanying drawings wherein:

FIG. 1 is a front view of a main heat-generating band according to an embodiment of the present application.

FIG. 2 is a rear view of the main heat-generating band according to an embodiment of the present application.

FIG. 3 is a front view of the main heat-generating band with its outer insulating layer being removed according to an embodiment of the present application.

FIG. 4 is a cross sectional view of the main heat-generating band according to an embodiment of the present application.

FIG. 5.1 is a front view of a controller of the main heat-generating band according to an embodiment of the present application.

FIG. 5.2 is a cross sectional view of the controller of the heat-generating band according to an embodiment of the present application.

FIG. 6 shows the electrical connection of various parts of the main heat-generating band according to an embodiment of the present application.

FIG. 7 is a front view of a supplemental heat-generating band according to an embodiment of the present application.

FIG. 8 is a rear view of the supplemental heat-generating band according to an embodiment of the present application.

FIG. 9 is a front view of the supplemental heat-generating band with its outer insulating layer being removed according to an embodiment of the present application.

FIG. 10 is a cross sectional view of the supplemental heat-generating band according to an embodiment of the present application.

FIG. 11 is a diagram showing the main heat-generating band being wrapped around a bottle according to an embodiment of the present application.

FIG. 12 is a diagram showing the main heat-generating band with opposite ends being fastened together according to an embodiment of the present application.

FIG. 13 is a diagram showing the main and the supplemental heat-generating bands being wrapped around a bottle according to an embodiment of the present application.

FIG. 14 is a diagram showing the supplemental heat-generating band with opposite ends being fastened together according to an embodiment of the present application.

FIG. 15 is a diagram showing the main heat-generating band being wrapped around an upper portion of the baby bottle in a feeding position according to an embodiment of the present application.

### DETAILED DESCRIPTION

Reference will now be made in detail to a preferred embodiment of the bottle temperature control apparatus disclosed in the present application, examples of which are also provided in the following description. Exemplary embodiments of the bottle temperature control apparatus disclosed in the present application are described in detail, although it will be apparent to those skilled in the relevant art that some features that are not particularly important to an understanding of the bottle temperature control apparatus may not be shown for the sake of clarity.

Furthermore, it should be understood that the bottle temperature control apparatus disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element, or is in mechanical or electrical communication with another element.

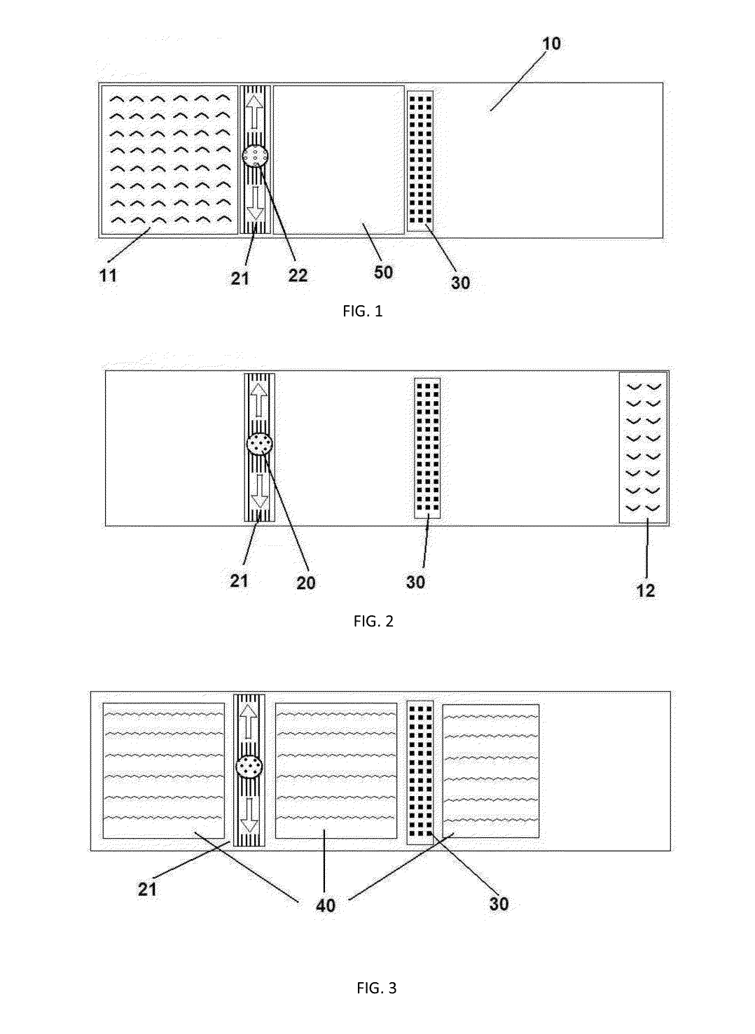

FIGS. 1-4 show various views of a main heat-generating band 10 according to an embodiment of the present application. The main heat-generating band 10 can be configured to wrap around an exterior wall of a baby bottle. Although it will be shown that the heat-generating band 10 is used to control the temperature of milk inside a baby bottle, it is understood that the heat-generating band 10 can be used to control the temperature of liquid inside any other kind of bottles.

The heat-generating band 10 may include one or more heaters 40 for heating up the baby bottle and hence the liquid, such as milk, inside the baby bottle. The heaters 40 can be sandwiched between an inner conductive layer 14 in contact with the exterior wall of the baby bottle during use and an outer insulating layer 13. According to the illustrated embodiment, there are three heaters 40.

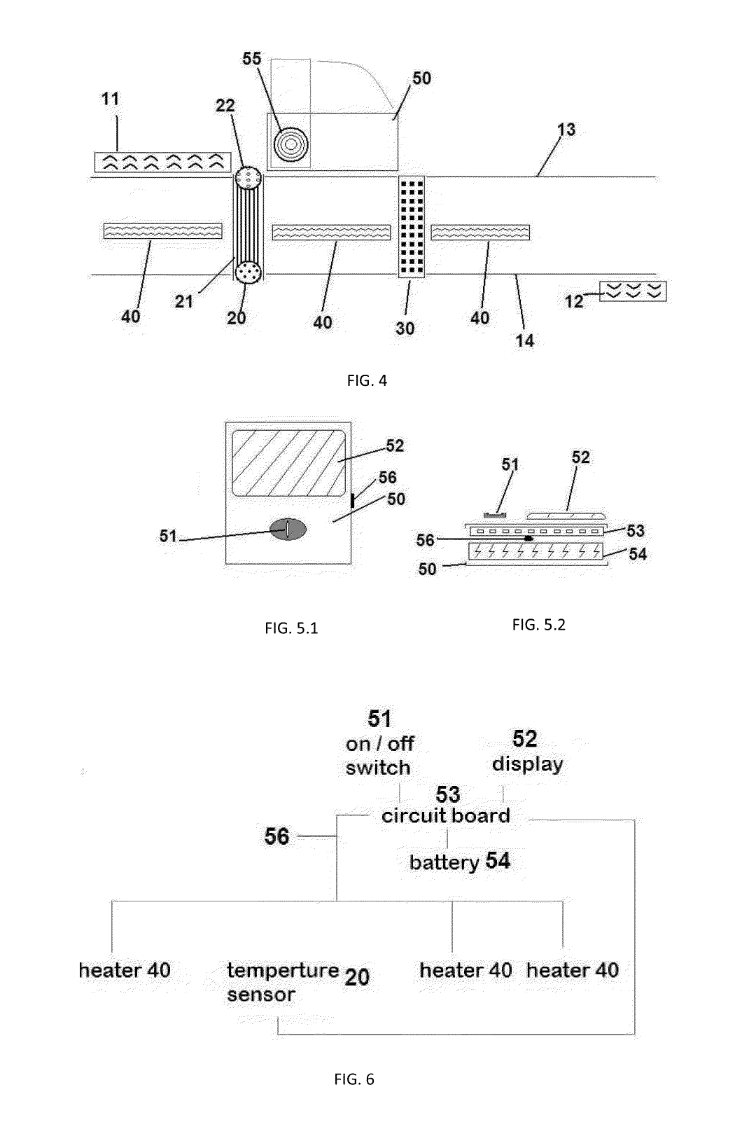

The main heat-generating band 10 may have two opposite ends provided with two cooperating fastening members 11, 12 respectively. The fastening members may be in the form of a Velcro™ fastener having a plurality of loops 11 provided on an outer surface of the outer insulating layer 13 at one end of the main heat-generating band 10, and a plurality of hooks 12 provided on an inner surface of the inner conductive layer 14 at the opposite end of the main heat-generating band 10, as best illustrated in FIG. 4. By means of the loops 11 and hooks 12, the two opposite ends of the main heat-generating band 10 can be easily attached together to form an annular band for wrapping around the exterior wall of the baby bottle, and can be easily detached from each other when desired.

It can be seen that the plurality of loops 11 may extend a certain length of the main heat-generating band 10 such that the plurality of hooks 12 can be attached to the plurality of loops 11 at different positions to form an annular band of different diameters. The main heat-generating band 10 may have a length sufficient to wrap around the exterior wall of baby bottles of various sizes. With the adjustable fastening members 11, 12, the main heat-generating band 10 can snugly wrap around the exterior wall of the baby bottle.

A temperature sensor 20 can be mounted on the main heat-generating band 10 in a position in contact with the exterior wall of the baby bottle for measuring the temperature of the liquid therein. The temperature sensor 20 can be disposed on the inner conductive layer 14.

The main heat-temperature band 10 may include a guiding rail 21 extending transversely on the main heat-temperature band 10. The temperature sensor 20 can slidably couple to the guiding rail 21. The temperature sensor 20 can be fixedly coupled to a slide button 22 disposed on the outer insulating layer 13 to facilitate the sliding of the temperature sensor 20 along the guiding rail 21. The temperature sensor 20 can move between a first position where the temperature sensor 20 is located at one side of the main heat-generating band 10 and a second position where the temperature sensor 20 is located at another side of the main heat-generating band 10.

The main heat-generating band 10 may be provided with a transparent window 30 extending transversely thereon. The transparent window 30 can be used to reveal the liquid and liquid level inside the baby bottle.

FIGS. 5.1, 5.2 and 6 depict a controller 50 of the main heat-generating band 10. The controller 50 may be mounted on the main heat-generating band 10 at a middle portion thereof. The controller 50 can be electrically connected to the heaters 40 and the temperature sensor 20. The controller 50 can be used to activate the heaters 40 when the temperature measured by the temperature sensor 20 drops below a predetermined temperature range and deactivate the heaters 40 when the temperature measured by the temperature sensor 20 rises above the predetermined temperature range. The predetermined temperature range may be between 37-42° C. which is close to breast milk and the temperature of a human body.

The controller 50 may include an on/off switch 52 to switch a power supply of the controller 50 on or off.

The controller 50 may include a display 51, such as an LCD display, for displaying the temperature being measured by the temperature sensor 20. For example, the display 51 may display a warning message “TOO COLD” when the temperature measured by the temperature sensor 20 drops below the predetermined temperature range, and display a warning message “TOO HOT” when the temperature measured by the temperature sensor 20 rises above the predetermined temperature range.

The controller 50 may include a circuit board 53 with a central processing unit configured to receive data transmitted from the temperature sensor 20, display the data on the display 51, and process the data transmitted from the temperature sensor 20.

The central processing unit provided on the circuit board 53 can be configured to automatically activate the heaters 40 when the temperature measured by the temperature sensor 20 drops below the predetermined temperature range, and automatically deactivate the heaters 40 when the temperature measured by the temperature sensor 20 rises above the predetermined temperature range.

A battery 54 can be used to supply electric energy to all the electrical components of the main heat-generating band 10 including the temperature sensor 20, the heaters 40, the display 52 and the circuit board 53.

The main heat-generating band 10 may further include an electrical connector 56 coupled to the controller 50. The electrical connector 56 can be used to connect to one or more supplemental heaters 40 for further heating up the liquid inside the baby bottle. The electrical connector 56 can be in the form of a jack for receiving therein a plug connected to the supplemental heaters 40 via an electric wire 61.

It can be seen that the controller 10 can be a single all-in-one unit that may include the display 51, the on/off switch 52, the circuit board 53, the battery 54 and the electrical connector 56. The display 51, the on/off switch 52, the circuit board 53, the battery 54 and the electrical connector 56 can be accommodated inside a controller housing. The display 51 may be provided on a front panel of the controller housing at a lower portion thereof. The on/off switch 52 may also be provided on the front panel of the controller housing at an upper portion thereof. The circuit board 53 may be mounted on an inner surface of the front panel of the controller housing. The battery 54 may be removably mounted at a rear portion of the controller housing for easy access and convenient replacement. The electrical connector 56 may be provided on a side panel of the controller housing at a middle portion thereof, as shown in FIG. 5.1.

As depicted in FIG. 4, the controller housing can be hingedly connected to the heat-generating band 10 at an outer side thereof by a hinge 55. This can facilitate the viewing of the display 51 located at the front panel of the controller housing of the baby bottle which can be adjusted at different positions and angles during feeding.

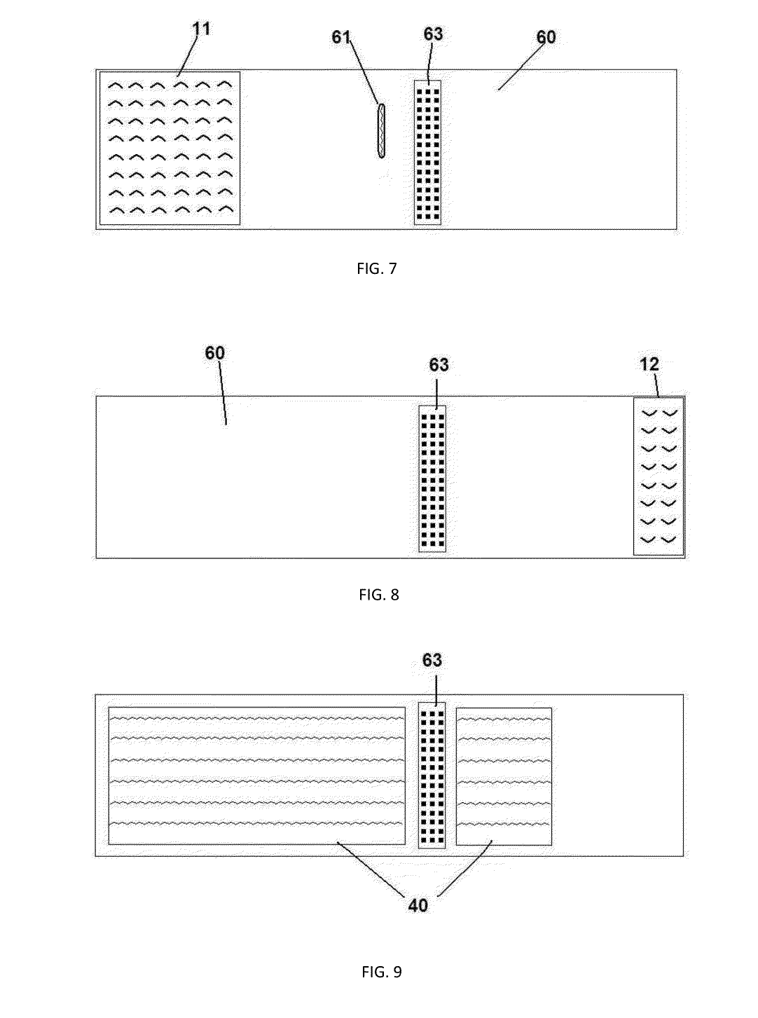

FIGS. 7-10 are various views of a supplemental heat-generating band 60 of the baby bottle temperature control apparatus of the present application. The supplemental heat-generating band 60 can also wrap around the exterior wall of the baby bottle. The supplemental heat-generating band 60 may include one or more supplemental heaters 40 for further heating up the baby bottle. This can increase the heating area and speed up the heating process.

Similar to the main heat-generating band 10, the supplemental heaters 40 of the supplemental heat-generating band 60 can be sandwiched between an inner conductive layer 14 in contact with the exterior wall of the baby bottle during use and an outer insulating layer 13. The supplemental heat-generating band 60 may also have two opposite ends provided with two cooperating fastening loops and hooks 11, 12 respectively.

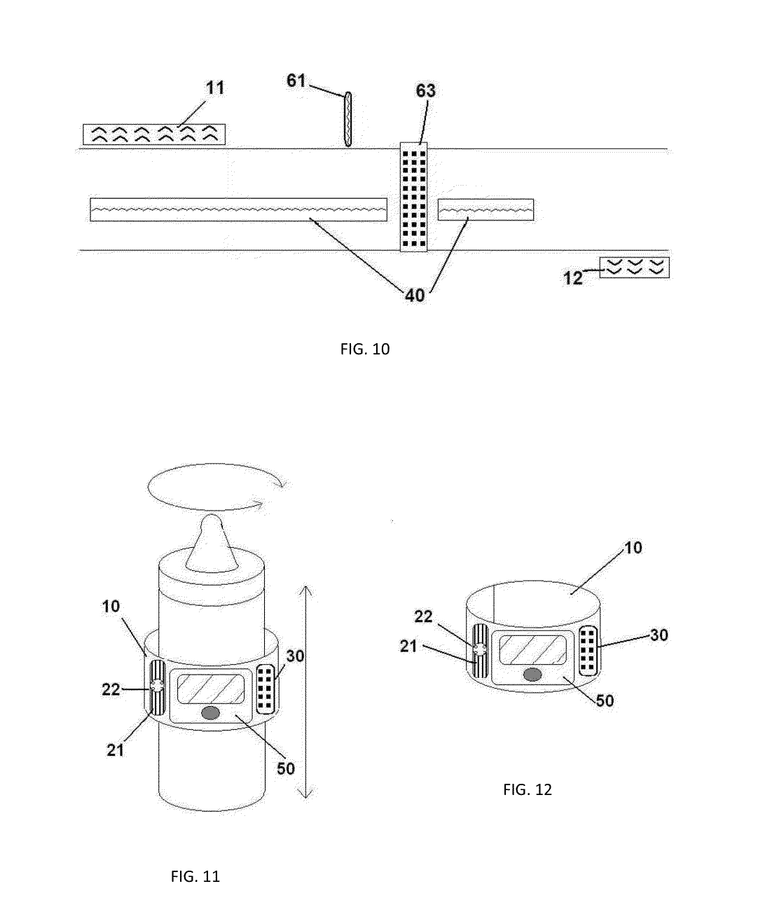

The loops 11 may be provided on an outer surface of the outer insulating layer 13 at one end of the supplemental heat-generating band 60, and the hooks 12 may be provided on an inner surface of the inner conductive layer 14 at the opposite end of the supplemental heat-generating band 60, as best illustrated in FIG. 10. By means of the loops 11 and hooks 12, the two opposite ends of the supplemental heat-generating band 60 can be easily attached together to form an annular band for wrapping around the exterior wall of the baby bottle, and can be easily detached from each other when desired.

The supplemental heat-generating band 60 can also be provided with a transparent window 63 extending transversely thereon. The transparent window 63 can be used to reveal the liquid and liquid level inside the baby bottle. The transparent window 63 of the supplemental heat-generating band 60 can be aligned with the transparent window 30 of the main heat-generating band 10, as shown in FIG. 13.

In use, a user can adjust the position of the main heat-generating band 10 by moving it up or down the exterior wall of the baby bottle, or rotate the main heat-generating band 10 around the exterior wall of the baby bottle, as illustrated by the arrows in FIG. 11, thereby moving the heater 40 and the temperature sensor 20 to a position where the liquid is located whether the bottle is oriented upright, sideway, or in an inverted and tilted feeding position.

When the baby bottle is standing upright and is half full of liquid at the bottom of the baby bottle, a user can attach the fastening members 11, 12 together to form an annular band, as depicted in FIG. 12, wrapping around a lower portion of the baby bottle. The user can then switch on the power to control the temperature of the liquid inside the upright baby bottle. The user can further move the temperature sensor 20 to a position closer to the bottom of the baby bottle by sliding the slide button 22 along the guiding rail 21.

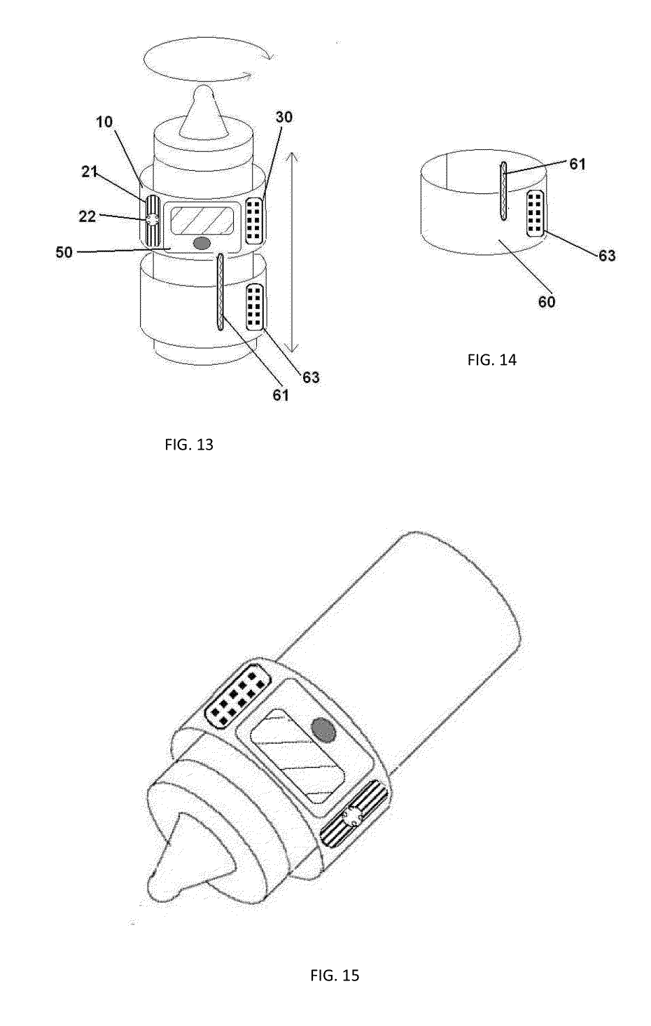

When the baby bottle is placed in an inverted and tilted feeding position, as illustrated in FIG. 15, the user can move the main heat-generating band 10 to an upper portion of the baby bottle in order to continuously control the temperature of the liquid inside the baby bottle during feeding. The user can rotate the main heat-generating band 10 around the baby bottle such that the temperature sensor 20 can be positioned at a lower side where the liquid is likely to be located. The user can further move the temperature sensor 20 to a position closer to the opening end of the baby bottle by sliding the slide button 22 along the guiding rail 21.

When the baby bottle is standing upright and is full of liquid, the user can wrap the main heat-generating band 10 around an upper portion of the baby bottle, and attach the fastening members 11, 12 together, as shown in FIG. 14, so as to wrap the supplemental heat-generating band 60 around a lower portion of the baby bottle, as depicted in FIG. 13. The supplemental heat-generating band 60 can be electrically connected to the main heat-generating band 10 through the electric wire 61. The user can then switch on the power to control the temperature of the liquid inside the baby bottle. When the baby bottle is placed in an inverted and tilted feeding position, both the main and supplemental heat-generating bands 10, 60 can continuously control the temperature of the liquid inside the baby bottle. The user can rotate the main heat-generating band 10 around the baby bottle such that the temperature sensor 20 is positioned at a lower side where the liquid is likely to be located. When necessary, the user can further move the temperature sensor 20 to a desired position by sliding the slide button 22 along the guiding rail 21.

A conventional hot-water type baby bottle warmer require the addition of water and heating up of water poured inside a container. The baby bottle temperature control apparatus of the present application does not require the addition of water. It simply uses a heater provided on the heat-generating band to heat up the milk inside a baby bottle.

A conventional baby bottle warmer cannot be used to warm up the milk inside a baby bottle during feeding. The baby bottle temperature control apparatus of the present application is a light-weight heat-generating band and can wrap around a baby bottle and warm up the milk inside the baby bottle during feeding.

It is not convenient to use and carry a conventional baby bottle warmer/pouch around because it requires AC power. The baby bottle temperature control apparatus of the present application does not require AC power and does not have any power cord. It only uses a small battery. Therefore, the baby bottle temperature control apparatus of the present application is more convenient to use and carry around.

Using a conventional baby bottle warmer or warming pouch, a feeder is not aware of the temperature of the milk inside the baby bottle because the conventional baby bottle warmer or warming pouch does not have the function of monitoring the milk temperature and would likely render the milk temperature to get too cold or too hot. The baby bottle temperature control apparatus of the present application comes with a temperature sensor and a display that would display the temperature being measured by the sensor and would also display a warning message if the temperature is too cold or too hot. Therefore, a feeder using baby bottle temperature control apparatus of the present application is fully aware of the temperature of the milk inside the baby bottle.

A user of a conventional baby bottle heating pouch cannot adjust the heating wires embedded inside the pouch to a position of the milk inside the baby bottle. This causes a waste of electrical energy. With the baby bottle temperature control apparatus of the present application, a user can easily adjust the heaters on the heat-generating band to a position of where the milk is located inside the baby bottle by simply moving a heat-generating band up or down the baby bottle, or using a main heat-generating band and a supplemental heat-generating band at the same time.

A user of a conventional baby bottle heating pouch cannot see the milk inside the baby bottle because the baby bottle is placed and hidden inside the pouch. With the baby bottle temperature control apparatus of the present application, a user can see the milk inside the baby bottle through the windows provided on the heat-generating bands.

A user of a conventional baby bottle heating pouch cannot adjust the size of the pouch and the heating wires embedded inside the pouch cannot be in close contact with the baby bottle. This greatly affects the heating efficiency of the pouch. With the baby bottle temperature control apparatus of the present application, the heaters on the main and supplemental heat-generating bands are always in close contact with the baby bottle.

While the baby bottle temperature control apparatus disclosed in the present application has been shown and described with particular references to a number of preferred embodiments thereof, it should be noted that various other changes or modifications may be made without departing from the scope of the appending claims.

What is claimed is:

1. A bottle temperature control apparatus comprising:
(a) a heat-generating band configured to wrap around an exterior wall of a bottle and provided with a heater;
(b) a temperature sensor mounted on the heat-generating band in contact with the exterior wall of the bottle for measuring the temperature of the liquid therein when the heat-generating band is wrapped around the exterior wall of the bottle;
(c) a controller mounted on the heat-generating band and connected to the heater and the temperature sensor, and configured to activate the heater when the temperature measured by the temperature sensor drops below a predetermined temperature range and deactivate the heater when the temperature measured by the temperature sensor rises above the predetermined temperature range; and
(d) an electrical connector coupled to the controller and adapted to be connected to a supplemental heater;
(e) wherein the heat-generating band can be moved up or down or around the exterior wall of the bottle thereby moving the heater and the temperature sensor to a position where the liquid is located whether the bottle is oriented upright, sideway, or in an inverted and tilted feeding position.

2. The apparatus as claimed in claim 1, wherein the heat-generating band has two opposite ends provided with two cooperating fastening members respectively.

3. The apparatus as claimed in claim 1, wherein the heat-generating band has a length sufficient to wrap around the exterior wall of bottles of various sizes.

4. The apparatus as claimed in claim 1, wherein the heat-generating band is provided with a transparent window through which the liquid and liquid level inside the bottle can be revealed.

5. The apparatus as claimed in claim 1, wherein the controller comprises a switch to switch a power supply of the controller on or off.

6. The apparatus as claimed in claim 1, wherein the controller comprises a display for displaying the temperature being measured by the temperature sensor.

7. The apparatus as claimed in claim 6, wherein the display displays a warning message “TOO COLD” when the temperature measured by the temperature sensor drops below the predetermined temperature range, and display a warning message “TOO HOT” when the temperature measured by the temperature sensor rises above the predetermined temperature range.

8. The apparatus as claimed in claim 1, wherein the heat-generating band comprises a guiding rail extending transversely thereon, whereby the temperature sensor is slidably coupled to the guiding rail and movable between a first position where the temperature sensor is located at one side of the heat-generating band and a second position where the temperature sensor is located at the other side of the heat-generating band.

9. The apparatus as claimed in claim 1, wherein the heater is sandwiched between an inner conductive layer in contact with the exterior wall of the bottle and an outer insulating layer.

10. The apparatus as claimed in claim 1, wherein the controller comprises a circuit board with a central processing unit configured to automatically activate the heater when the temperature measured by the temperature sensor drops below a predetermined temperature range, and automatically deactivate the heater when the temperature measured by the temperature sensor rises above the predetermined temperature range.

11. The apparatus as claimed in claim 1, wherein the controller comprises a switch, a display, a central processing unit and a battery.

12. The apparatus as claimed in claim 1, wherein the controller is accommodated in a controller housing which is hingedly connected to the heat-generating band at an outer side thereof by a hinge.

13. The apparatus as claimed in claim 1, wherein the controller comprises a central processing unit configured to receive data transmitted from the sensor, display the data on a display, process the data, activate the heater when the temperature measured by the temperature sensor drops below a predetermined temperature range, and deactivating the heater when the temperature measured by the temperature sensor rises above the predetermined temperature range.

14. The apparatus as claimed in claim 1, wherein the controller comprises a battery for supplying electric energy to the sensor, the heater and the controller.

15. The apparatus as claimed in claim 1, further comprising a supplemental heat-generating band configured to wrap around the exterior wall of the bottle and carrying the supplemental heater.

16. The apparatus as claimed in claim 15, wherein the supplemental heat-generating band is provided with a transparent window through which the liquid and liquid level inside the bottle can be revealed.

17. The apparatus as claimed in claim 1, comprising a plurality of heaters disposed around the exterior wall of the bottle.

18. The apparatus as claimed in claim 8, wherein the temperature sensor is fixedly coupled to a slide button so as to facilitate the sliding of the temperature sensor along the guiding rail.

19. The apparatus as claimed in claim 1, wherein the electrical connector is connected to the supplemental heater by an electrical wire.

20. The apparatus as claimed in claim 1, wherein the bottle is a baby bottle.
